(19) United States
(12) Patent Application Publication
(10) Pub. No.: US 2023/0191988 A1
(43) Pub. Date: Jun. 22, 2023

(54) Vehicle Alert System

(71) Applicant: Matthew Rodriguez, San Antonio, TX (US)

(72) Inventor: Matthew Rodriguez, San Antonio, TX (US)

(21) Appl. No.: 18/083,341

(22) Filed: Dec. 16, 2022

Related U.S. Application Data
(60) Provisional application No. 63/290,175, filed on Dec. 16, 2021.

(51) Int. Cl. B60Q 1/50; B60Q 1/44

(52) U.S. Cl. CPC B60Q 1/535; B60Q 1/44; B60Q 2400/50

(57) ABSTRACT

A beacon provides an image projected onto a roadway at a distance from the vehicle to alert other vehicles as to the presence and speed and/or the deceleration (braking) of the vehicle. The beacon can include a laser that projects an image onto the roadway at a distance behind the vehicle. The laser is able to project this image through fog or other low visibility conditions. The image projected onto the roadway can be a recognizable image such as a universally recognized warning symbol. Alternatively, or additionally, a beacon can be mounted to a front of a vehicle which can alert a moving leading vehicle as to the presence of a moving trailing vehicle in low visibility conditions. The beacon can also be used to alert the driver of inadvertent crossing the roadway lane divider markings either visibly or electronically, in low visibility conditions.

This application claims the benefit of U.S. Provisional application Ser. No. 63/290,175, filed Dec. 16, 2021, in its entirety.

### BACKGROUND

Weather conditions can reduce vehicle-driving visibility, especially during fog. Even using fog lights, visibility in fog, rain or snow can be challenging. This is especially true when following a vehicle. During a heavy fog, for example, the tail lights of a moving leading vehicle may not give sufficient warning to a moving trailing vehicle to brake if the moving leading vehicle stops suddenly. During a heavy fog, for example, the tail lights of a moving leading vehicle may not give sufficient indication of the moving leading vehicles position on the roadway.

The present inventor has recognized that it would be advantageous to provide an effective system to prevent rear end collisions in low visibility driving, such as presented by fog. The present inventor has recognized that it would be advantageous to provide an effective system to provide position information for both a moving leading vehicle and a moving trailing vehicle with respect to the other moving leading vehicle and the moving trailing vehicle, during low visibility conditions.

### SUMMARY

The exemplary embodiment of the present invention provides a beacon that provides an image projected onto a roadway at a distance from the vehicle to alert other vehicles as to the presence and speed and/or the deceleration (braking) of the vehicle. The image is of a brightness and/or intensity that it can be seen even in low visibility conditions.

Advantageously, the beacon comprises a laser that projects an image onto the roadway at a distance behind the vehicle. The laser is able to project this image through fog or other low visibility conditions. The image projected onto the roadway can be a recognizable image such as a universally recognized warning symbol.

Alternatively, or additionally, a beacon can be mounted to a front of a vehicle which can alert a moving leading vehicle as to the presence of a moving trailing vehicle in low visibility conditions.

The beacon can also be used to alert the driver of inadvertent crossing the roadway lane divider markings either visibly or electronically, in low visibility conditions.

The laser can be an LED laser. The laser can direct a beam into a lens to widen the image. The widened image can be projected through a mask or filter to project a recognizable image on the roadway.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a schematic view of two vehicles, each having a beacon according to an exemplary embodiment of the present invention, projecting from the rear of the vehicle;

FIG. 2 is a schematic view of one of the vehicles having the beacon according to an exemplary embodiment of the present invention, projecting from the front of the vehicle; and

FIG. 3 is an enlarged schematic view of the beacon according to an exemplary embodiment of the present invention;

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application incorporates U.S. Provisional application Ser. No. 63/290,175, filed Dec. 16, 2021, in its entirety.

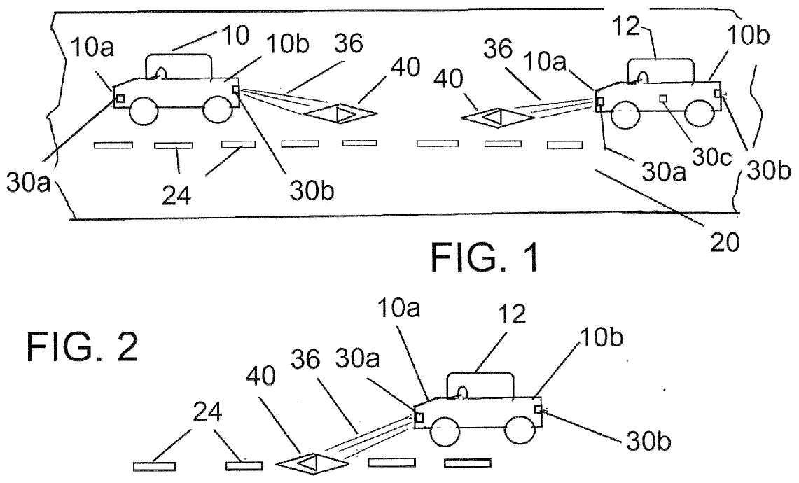

FIG. 1 illustrates two vehicles, a moving leading vehicle 10, and a moving trailing vehicle 12, each having a front end 10a and a rear end 10b. The vehicles are shown moving on a two-way roadway divided by lane markers 24. Each vehicle can be provided with light-projecting beacons 30a, 30b, such as using an LED laser or other high intensity light source, mounted on the front end 10a and/or the rear end 10b, respectively. The beacons 30a, 30b are powered by a power source (described below) to project an image beam 36 onto the roadway in front of, and/or behind the vehicle forming an image 40 behind and/or in front of each of the vehicles 10, 12.

Advantageously, the angle of projection of the beacons 30a, 30b is set or is adjustable at an angle downward from horizontal of between approximately −277 degrees (moderately tilted) to less than −90 degrees (aimed straight down) to display the image at a select distance from the vehicle in front of, and/or behind the vehicle. Advantageously, the angle of projection can be controlled automatically by the vehicle, dependent of the vehicle speed and/or a sensed visibility condition, determined by an optical sensor 30c.

In low visibility conditions, such as in a fog condition, where conventional fog lights or conventional headlights are inadequate to alert other drivers of the presence of a vehicle, the image 40 on the roadway is more easily observed by other vehicles either in front of or behind the vehicle. For a forward projecting device 30a, a moving leading vehicle can observe the presence of a moving trailing vehicle and for the rearward projecting device 30b, a moving trailing vehicle can observe the presence of a moving leading vehicle.

FIG. 2 illustrates the vehicle 12 having the beacon 30a mounted near-to a front end 10a of the vehicle 12 and arranged to project the image 40 onto the roadway 20 in front of the vehicle. As illustrated, the image 40 can react to the dividers 24 on the roadway to alert the driver of vehicle 12 that the vehicle has crossed over into the opposing lane. This reaction can be a visible reaction or possibly an electronic warning reaction.

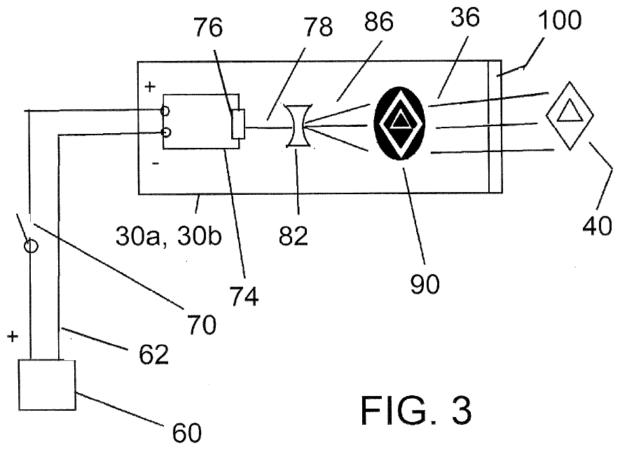

FIG. 3 is an enlarged schematic view of the beacon 30a, 30b shown in FIGS. 1 and 2. The beacon is powered by a power source 60 such as by a vehicle battery or other power source such as a dedicated battery. The power source can be connected to some system of vehicle lighting already wired to the vehicle battery. The power source is connected by wires 62 via a switch 70 to a laser 74. The laser can be a class 3a laser, such class including laser pointers. The laser includes an emitter 76 that projects as narrow light beam 78 onto a lens 82, such as a biconcave lens that projects a widened light beam 86 onto a filter or mask 90 that modifies the widened beam to project the image beam 36 creating the image 40 on the roadway. Preferably the image 40 is a recognizable image such as a triangular warning symbol.

The laser 74 can include a laser pointer such as a diode emitter. A laser diode is a low power usage light using an LED and a series of amplifiers. The laser color can be selected to determine the brightness of the image 40, the distance projected from the vehicle and the potency of the light. Green is advantageous as being the most visible to the human eye.

The image is selected based on the reflectivity of the roadway surface. Asphalt reflects light at 5.2% for green and 10.3% for red. The lighting system can be designed to have a low reflectivity off the roadway but still be visible enough to alert drivers in any weather, including fog.

From the foregoing it will be observed that numerous variations and modifications may be effected without departing from the spirit and scope of the invention. It is to be understood that no limitation with respect to the specific apparatus illustrated herein is intended or should be inferred.

The invention claimed is:

1. A laser beacon for a vehicle operated on a roadway, the beacon carried by the vehicle, or incorporated into the vehicle, comprising a laser optically connected to a lens arranged to project an image onto a roadway at a distance from the vehicle.

2. The laser beacon according to claim 1, wherein the beacon is mounted to project the image behind the vehicle.

3. The laser beacon according to claim 1, wherein the beacon is mounted to project the image in front of the vehicle.

4. The laser beacon according to claim 1, comprising an optical mask receiving laser light from the lens and converting the light such that the image displayed on the roadway is a recognizable symbol.

5. The laser beacon according to claim 1, wherein the beacon is arranged to project the image at an angle of between −27.5 degrees and −90 degrees from horizontal in front of or behind the vehicle.

6. A beacon for a vehicle operated on a roadway, comprising a light emitter carried by, or incorporated into, the vehicle and arranged to project an image onto a roadway at a distance from the vehicle.

7. The beacon according to claim 6, wherein the emitter comprises a laser.

8. The beacon according to claim 6, wherein the emitter comprises an LED light.

9. The beacon according to claim 6, comprising a lens and wherein the emitter is optically coupled to the lens to widen the light from the laser to make the image wider.

10. The beacon according to claim 9, comprising a mask optically coupled to the lens to make the image a recognizable symbol projected onto the roadway.

11. The beacon according to claim 6, wherein the beacon is configured to illuminate or otherwise react to roadway lane markings to alert the driver of inadvertent lane changing during low visibility conditions.
